(19) United States
(12) Patent Application Publication
(10) Pub. No.: US 2022/0153181 A1
(43) Pub. Date: May 19, 2022

(54) Locking Wheel Chock

(71) Applicants: Ryker Alan Sullivan, Lenoir city, TN (US); Michael Thomas Sullivane, Lenoir city, TN (US)

(72) Inventors: Ryker Alan Sullivan, Lenoir city, TN (US); Michael Thomas Sullivane, Lenoir city, TN (US)

(21) Appl. No.: 17/495,791

(22) Filed: Oct. 6, 2021

Related U.S. Application Data
(60) Provisional application No. 63/087,260, filed on Oct. 4, 2020.

(51) Int. Cl. B60P 3/077; B62H 3/04; B60P 7/08; B62H 5/14

(52) U.S. Cl. CPC B60P 3/077; B62H 5/145; B60P 7/08; B62H 3/04

(57) ABSTRACT

A wheel chock assembly to secure a wheel of a motorcycle and/or bicycle by encasing the wheel and secured by a lockable lock pin. The wheel chock assembly can be used with one of the various mounting assemblies and with the frame securement collar assembly. The wheel chock assembly when mounted on one of the various mounting assemblies can be used to secure a motorcycle and/or bicycle on the bed of a truck or on the bed wall of a truck, trailer floor, trailer wall or trailer railing and even in a garage on the floor or wall. The securement collar assembly is used either around the steering column and frame attaching to the wheel chock assembly's lock pin for securement or between the rear tire and the frame attaching to the wheel chock assembly's lock pin for securement.

### FIELD OF THE INVENTION

Some embodiments disclosed in this application relate to devices used to secure at least one motorcycle or other similar vehicle to the bed of a truck or floor/railing of a transport vehicle including, but not limited to, recreational vehicles (RV's), toy haulers, and trailers.

### BACKGROUND OF THE INVENTION

Transportation of motorcycles and bicycles in pickups, trucks and trailers are a common occurrence. Various wheel chocks systems have been developed to allow for transportation of motorcycles and/or bicycles in pickups, trucks and trailers. Some of the various wheel chocks offer some type of securement from theft while others do not. Many of these traditional wheel chock systems are physically attached to a pickup, truck and trailer. Typically, these systems require significant time and effort to install and de-install. These systems are not typically easily reconfigurable from one type of vehicle or trailer to another and take up a lot of floor space when not in use and limits what a person can haul. Additionally, these various wheel chocks only clamps a wheel which limits their potential for securing the motorcycle and/or bicycle from theft.

The embodiment of the present invention seeks to provide solutions to these problems by providing a wheel chock assembly that secures the wheel of a motorcycle and/or bicycle that is easily adaptable to many types of pickups, trucks, trailers and even garages when storing. Additionally, the embodiment of the present invention used alone or along with the securement collar assembly adds a presence of theft deterrent when the user is away from their hauling vehicle,(ie. shopping, eating, sleeping). The securement collar assembly allows the user to add another level of anti-theft to their motorcycle and/or bicycle. The securement collar assembly is used either around the steering column and frame attaching to the chock assembly's lock pin for securement or between the rear tire and the frame attaching to the chock assembly's lock pin for securement. The securement collar assembly is made of multiple sections that allow the user to re-configure the length to accommodate different types and or style of motorcycles and/or bicycles.

The embodiment of the present invention seeks to provide a wheel chock assembly that is designed to have a wheel of a motorcycle and/or bicycle inserted between the two moveable door panels. The door panels have elongated slots as to allow a lock pin to pass through from one door panel to the other door panel, then a lock is applied to the lock pin for securement. When a wheel is placed between the two moveable door panels the lock pin will be inserted through the first door panel's elongated slot then pass through between the wheel rim and the wheel hub exciting through the second door panel's elongated slot and then a lock is applied to the lock pin for securement of the motorcycle and/or bicycle. The embodiment of the present invention of a wheel chock assembly can be used with any one of several mounting assemblies that the is needed to fit the application of the installation. The versatility of the wheel chock assembly allows the moveable door panels to be securely placed from a 0 degree to a flat 180 degrees that allow for maximum use of floor area when not in use or can be quickly removed for full usage of the floor area of the pickup, trailer or garage. Additionally, the embodiment of the present invention of a wheel chock assembly can be easily adaptable to different types of truck beds, trailers or garages with one of the mounting assemblies allowing the motorcycle and/or bicycle enthusiast to use any mode of hauling transportation or storage they desire.

The embodiment of the present invention solves several issues that motorcycle and/or bicycle owner might encounter when trying to use the cumbersome and or permanently mounted wheel chocks currently in use. The embodiment of the present invention is adaptable to pickup beds, flatbed trucks, trailer floors, trailer handrails, concrete garage floors and even garage walls. Any one of the embodiments of the present invention's configurations will allow multiple side by side usage for multiple motorcycles and/or bicycles to be securely hauled or stored.

### SUMMARY OF THE INVENTION

In one embodiment of the invention a motorcycle and/or bicycle wheel chock assembly and anti-theft assembly that is able to be easily used with the securement collar assembly and interchangeable with multiple mounting assemblies as to be used in pickup trucks, trucks or trailers to maximize security and cargo floor space, comprising a solid backing plate with mounting holes, hinged sides, hinged doors, solid doors with elongated slots, various mounting apparatuses, lockable lock-pin and securement collar assembly.

Also, in one embodiment a solid backing plate has multiple holes to allow for height adjustment and to allow the backing plate to be attached to various mounting assemblies as to be installed on various vehicles and trailers. Also, in one embodiment a solid backing plate has hinges on both sides to accommodate the hinged doors. Also, in one embodiment are hinged doors that are moveable from 180 degrees to 0 degrees. The doors have internal mechanisms inside the hinges that allow the doors to be secured at the 180 degree position and the 90 degree position. The range of degrees from 180 to 0 allows the user to mount a motorcycle and/or bicycle at different angles for their needs and when not in use the user can arrange the moveable doors to allow for maximum floor space for cargo. Also, in one embodiment the hinged doors each have elongated slots to whereas a lockable lock-pin can be inserted and secured. The lock-pin is to be inserted through the elongated slot of one door, pass through the wheel of the motorcycle and/or bicycle then exiting through the elongated slot of the second door and then a locking device can secure the lock-pin.

In another aspect of the invention a securement collar assembly is used either around the steering column and frame attaching to the wheel chock assembly's lock pin for securement or between the rear tire and the frame attaching to the wheel chock assembly's lock pin for securement. The securement collar assembly has certain design angles and multiple interchangeable sections of varying lengths to allow the user to re-configure the securement collar assembly to fit their different type of motorcycle and/or bicycle.

In another aspect of the invention is one of the various mounting assemblies called the pickup truck bed mount assembly. The pickup truck bed mount assembly with the wheel chock assembly mounted to it, is then installed to the front wall of the pickup truck bed and then ready to receive a wheel of a motorcycle or bicycle. The pickup bed mount assembly is designed so that the user can install multiple units on the pickup bed wall so they can haul multiple motorcycles and/or bicycles. The pickup bed mount assembly is designed to utilize the wheel chock assembly's moveable doors so that when the doors are flattened out to the 180 degree position the user will have maximum cargo space available when not hauling motorcycles and/or bicycles. Another design of the pickup bed mount assembly is that is can be quickly be installed and uninstalled by the user in case the user needs to switch pickup trucks or trailers.

In another aspect of the invention is one of the various mounting assemblies called the floor mount assembly. The floor mount assembly with the wheel chock mounted to it, that once secured to the floor of a pickup truck, flat bed truck, trailer or garage is then ready to receive a wheel of a motorcycle or bicycle. The floor mount assembly is designed so that the user can install multiple units on a pickup truck bed, flat bed truck, trailer, garage so they can haul or store multiple motorcycles and/or bicycles. The floor mount assembly is designed that the upright structure that the wheel chock assembly mounts directly to can be easily detached from the base that is secured to the floor of a pickup truck bed, flat bed truck, trailer, garage to allow for maximum floor cargo area usage.

In another aspect of the invention is one of the various mounting assemblies called the rail mount. The rail mount assembly with the wheel chock assembly mounted to it, is then installed to the railing of a trailer and then ready to receive a wheel of a motorcycle and/or bicycle. The rail mount assembly is designed so that the user can install multiple units on a trailer's railing so they can haul multiple motorcycles and/or bicycles. The rail mount assembly is designed to utilize the wheel chock assembly's moveable doors so that when the doors are flattened out to the 180 degree position the user will have maximum cargo space available when not hauling motorcycles and/or bicycles. Another design of the rail mount assembly is that it can be installed on round tube railing, square tube railing or angle iron railing.

In another aspect of the invention is one of the various mounting assemblies called the detachable mount assembly. The detachable mount assembly is designed in two parts. One section, part A, is secured to one of the above mentioned mounting assemblies and the other section, part B, is secured to the wheel chock assembly. With the removal or installation of one fastener the wheel chock assembly and detachable mount assembly part B are quickly removed or re-installed. The detachable two part mount assembly with the wheel chock assembly mounted to it and when installed to the one of the other mounting assemblies, (ie.. rail mount, bed mount, floor mount) listed above allows the wheel chock assembly to be quickly released from a mounting assembly so that the wheel chock assembly/part B can be easily moved into storage or even to one of the other mount assemblies that have a part A already attached so that the user can quickly transition between vehicles and trailers.

### DETAILED DESCRIPTION OF THE INVENTION

Referring now to FIG. 1, throughout this description and the accompanying drawings reference is made to principles of the invention through the use of exemplary embodiments. It should be understood that the application is not limited to the details or specific methodologies set fourth herein. It should also be understood that the terminology used herein is for the purpose of description only and should not be regarded as limiting. In the following description, for purpose of explanation, numerous specific details are set fourth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

The inventor provides an embodiment of the present invention of a wheel chock assembly design that has moveable hinged doors and multiple mounting assemblies that allow the end user options on where and how to mount the wheel chock invention. The embodiment of the present invention is described in enabling detail in the following examples, which may represent more than one embodiment of the present invention.

Referring to FIG. 1A, the backplate 101 has several functions as an installation mounting base, hinges designed to hold the internal mechanisms, multiple holes to allow for height adjustments and strength for security. The backplate and door hinge assemblies are designed to keep the mechanics internal with a clean aesthetic appearance. The internal hinge mechanics are designed to lock the doors into 90 degree and 180 degree positions and then any degree angle between 90 degree/180 degrees to 0 degrees will have friction resistance to keep the doors from free swinging back and forth.

Referring to FIG. 1B, two moveable door panels 102 are hinged and are of substantial size and made with solid material. The doors are able to swing from range of 0 degrees through 180 degrees. The doors have elongated slots 109 to allow the user to insert the lock pin 110 into the desired position through the rim and wheel hub of the motorcycle for securement.

Referring to FIG. 1B, doors have an elongated slots 109 to allow the user to insert the lock pin 110 into the desired position through the rim and wheel hub of the motorcycle and/or bicycle. The lock pin 110 will have a plate on one end to act as a stop guide and the stop plate 111 has a specific design feature of angled slots 120 as to hold the lock pin 110 into one of the elongated door slots 109 for storage when not in use. On the opposing end the lock pin 110 will have a hole(s) 123 to accept a securement type lock. The plate on the lock pin 110 will be inserted into the door slot 109 horizontally and rotated 90 degrees utilizing one of the elongated slots 109 to drop the end of the rod into the elongated slot wedging it in place for storage. Referring to FIG. 1G is another version of the embodiment of the lock pin 110 is a lock pin with a curve to the rod/shaft as to allow the wheel chock assembly doors to be secured when the wheel chock assembly has received a wheel of a motorcycle and/or bicycle at an angle.

Referring to FIG. 1L, detachable door pads can be used when hauling a bicycle 318 and/or motorcycle 232 to firmly grip a smaller diameter tire/rim between the wheel chock assembly doors 109. Detachable Door pads quickly install to the inner side of each of the wheel chock assembly doors 109. Soft absorbing material is used on the detachable door pads. It will appear to one with skills in the art of motorcycle 232/or bicycle 318 wheel chock 100 restraint systems that the invention may be provided using some or all of the mentioned features and components without departing from the spirit and scope of this present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

Referring to FIG. 2L a framework assembly 200 to be installed on a pickup truck's 233 front bed wall to accommodate the wheel chock 100 assembly for the transportation and securement of motorcycles 232 and/or bicycles 318. The bed mount assembly 200 quickly and securely attaches to a pickup truck bed wall without damaging the truck. The bed mount assembly 200 can be used in multiples allowing the user to haul several motorcycles 232 and/or bicycles 318. The pickup bed mount assembly 200 is also designed to utilize the wheel chock 100 assembly's moveable doors 109 so that when the doors are flattened out to the 180 degree position the user will have maximum cargo space available when not hauling motorcycles 232 and/or bicycles 318. Another design of the pickup bed mount assembly 200 is that it can be quickly installed and uninstalled by the user skilled in the art of the present apparatus in case the user desires to switch pickup trucks 233.

Referring to FIG. 3D a solid framework assembly to be installed on the floor of a truck or trailer to accommodate the wheel chock assembly 100 for the transportation and securement of motorcycles 232 and/or bicycles 318. The floor mount assembly 300 quickly and securely attaches to a truck 233, trailer 317 or garage floor. The floor mount assembly 300 can be used in multiples allowing the user to haul or store several motorcycles 232 and/or bicycles 318. The floor mount assembly 300 is also designed to utilize the wheel chock assembly's moveable doors 109 so that when the doors are flattened out to the 180 degree position the user will have maximum cargo space available when not hauling motorcycles 232 and/or bicycles 318. Another design feature of the floor mount assembly 300 is that it can be quickly installed and uninstalled by the user skilled in the art of the present apparatus in case the user desires to switch pickup trucks 233.

Referring to FIG. 4C of the rail mount assembly 400 is designed for the user who does not want to modify their trailer 317 and would prefer a simple bolt on application. The user can install as many rail mount 400/wheel chock 100 assemblies as the user desires for the transportation of said motorcycles 232 and/or bicycles 318 on the utility trailer 317. The rail mount assembly 400 is used to attach the wheel chock assembly 100 to the railing of utility trailers 317 to be able to transport motorcycles 232 and/or bicycles 318. The design aspects of the rail mount assembly 400 allows for the accommodation of different types and sizes of railings found on utility trailers 317, FIG. 4A showing square tubing, round tubing and angle iron.

Referring to FIG. 5B detachable mount assembly 500 that when used in conjunction with the wheel chock assembly 100 and mounted to one of the other mount assemblies, ie.. bed mount 200, floor mount 300 and rail mount 400. One section, part A 501, is secured to one of the mounting assemblies mentioned above and the other section, part B 502, is secured to the wheel chock assembly 100. With the removal or installation of one fastener the wheel chock assembly 100 and detachable mount apparatus part B 502 is quickly removed or re-installed to another vehicle, trailer or placed into storage.

Referring to FIGS. 6D & 6H the securement collar assembly 600 is designed as an extra security feature to complement the wheel chock assembly 100. The securement collar assembly 600 attaches to the wheel chock assembly 100 with the lock pin 110 and secured by a lock. The securement collar assembly 600 can be used either with motorcycles 232 and/or bicycles 318 and the user has a choice of installation of either; between the frame and the steering components and/or between the subframe and rear wheel.

### BRIEF DESCRIPTION OF THE DRAWINGS

The accompanying drawings illustrate various examples of the exemplary embodiments described herein and are part of the specification. The illustrated exemplary embodiments are merely examples and do not limit the scope of the claims.

FIG. 1 is a view of the wheel chock assembly according to an embodiment of the present invention.

FIG. 1A is an exploded view of the wheel chock assembly according to an embodiment of the present invention.

FIG. 1B is a side view of wheel chock assembly door and hinge according to an embodiment of the present invention.

FIG. 1C is a view of door pins and parts according to an embodiment of the present invention.

FIG. 1D is a view of the wheel chock assembly lock pin according to an embodiment of the present invention.

FIG. 1E is a view of the wheel chock assembly bolt hole pattern according to an embodiment of the present invention.

FIG. 1F is a view of an optional lock pin according to an embodiment of the present invention.

FIG. 1G is another view of an optional lock pin that is curved according to an embodiment of the present invention.

FIG. 1H is a front view of the wheel chock assembly doors showing the doors at different angles according to an embodiment of the present invention.

FIG. 1I is an overhead view of the wheel chock assembly doors showing the doors at different angles according to an embodiment of the present invention.

FIG. 1J is a front view of the wheel chock assembly doors showing the door pads of different mounting designs according to an embodiment of the present invention.

FIG. 1K is a side view of the wheel chock assembly magnetic door pad according to an embodiment of the present invention.

FIG. 1L is a front view of the wheel chock assembly magnetic door pad according to an embodiment of the present invention.

FIG. 1M is a side view of the wheel chock assembly clamping door pad according to an embodiment of the present invention.

FIG. 1N is a front view of the wheel chock assembly door clamping according to an embodiment of the present invention.

FIG. 2 is a view of the bed mount assembly showing the external and internal mechanical parts.

FIG. 2A is a view of the right side of the bed mount assembly.

FIG. 2B is a view of the left side of the bed mount assembly.

FIG. 2C is a view of the spool assembly mechanicals of the bed mount assembly.

FIG. 2D is a view of the spool cradle parts of the bed mount assembly.

FIG. 2E is a view of the assembled spool cradle of the bed mount assembly.

FIG. 2F is a view of the rear of the bed mount assembly.

FIG. 2G is a view of both left and right side of the bed mount assembly.

FIG. 2H is a view of the front angle of the retention hook device of the bed mount assembly.

FIG. 2I is a view of the parts of the retention hook device of the bed mount assembly.

FIG. 2J is a view of the both left and right sides of the retention hook device of the bed mount assembly.

FIG. 2K is a view of the two bed mount/wheel chock assemblies on the front wall of a pickup bed. Left wheel chock assembly is shown with the doors at the 90 degree position and the wheel chock on the right is showing the doors at the flat 180 degree position.

FIG. 2L is a view of the bed mount/wheel chock assemblies in use on a pickup truck.

FIG. 2M is a view of the bed mount/wheel chock assemblies in use on a pickup truck with the doors close to the 90 degree angles that would be used to haul a motorcycle and/or bicycle.

FIG. 2N is a view of the bed mount/wheel chock assemblies in use on a pickup truck in the flat 180 degree position to maximize the cargo area.

FIG. 2O is an exploded view of the retention hook device of the bed mount assembly.

FIG. 2P is a view of the assembled retention hook device of the bed mount assembly.

FIG. 3 is a view of the front side of the floor mount assembly.

FIG. 3A is a view of the rear side of the floor mount assembly.

FIG. 3B is a view of the side of the floor mount assembly on the base.

FIG. 3C is a view of the floor mount assembly's lock pin.

FIG. 3D is a view from above of the floor mount/wheel chock assemblies with a secured motorcycle on a utility trailer.

FIG. 3E is a view of the floor mount/wheel chock assemblies on a utility trailer along with a rail mount assembly.

FIG. 3F is a view of the floor mount/wheel chock assemblies on a utility trailer with a secured motorcycle.

FIG. 3G is a view of the floor mount/wheel chock assemblies on a garage floor with a secured motorcycle.

FIG. 3H is a view of the floor mount/wheel chock/securement collar assemblies on a utility trailer with a secured motorcycle.

FIG. 3I is a view of the floor mount/wheel chock/securement collar assemblies on a garage floor with a secured bicycle.

FIG. 4 is a front view of the rail clamp assembly.

FIG. 4A is a view of the rail mount assembly installed on round tubing, square tubing and angle iron.

FIG. 4B is a view of the rail mount assembly installed on the right side of a utility trailer's railing.

FIG. 4C is a view of the rail mount/chock assemblies installed on a utility trailers railing hauling a motorcycle.

FIG. 5 is a front view of detachable mount assembly parts A & B.

FIG. 5A is a view of side view detachable mount assembly parts A & B.

FIG. 5B is a detached side view of the detachable mount assembly and wheel chock assembly used with a floor mount assembly

FIG. 5C is a view an attached side view of the detachable mount assembly and wheel chock assembly used with a floor mount assembly

FIG. 5D is a view of an attached detachable mount assembly and wheel chock assembly used with the pickup truck bed mount assembly.

FIG. 5E is a view of part A of the detachable mount assembly used with the pickup truck bed mount assembly.

FIG. 6 is a view of securement collar with the legs straight and angled.

FIG. 6A is a view of securement collar with interchangeable sections.

FIG. 6B is a view of the optional securement collar with the legs straight and angled.

FIG. 6C is a view of the optional securement collar with interchangeable sections.

FIG. 6D is a view from above of the securement collar used with a floor mount/wheel chock assemblies on a motorcycle.

FIG. 6E is a view from above of the securement collar used with a floor mount/wheel chock assemblies on a motorcycle and a rail mount/wheel chock assemblies on a bicycle.

FIG. 6F is a view of a securement collar used with a floor mount/wheel chock assemblies in the rear location on a motorcycle on a trailer.

FIG. 6G is a view of a securement collar used in the upper location with a bed mount/wheel chock assemblies on a motorcycle in a pickup truck.

FIG. 6H is a view of a securement collar used in the rear location with a bed mount/wheel chock assemblies on a motorcycle in a pickup truck.

FIG. 6I is a view of a securement collar used in the upper location with a floor mount/wheel chock assemblies on a bicycle in a garage.

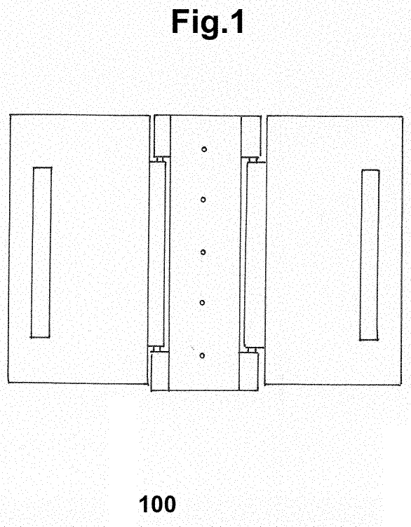

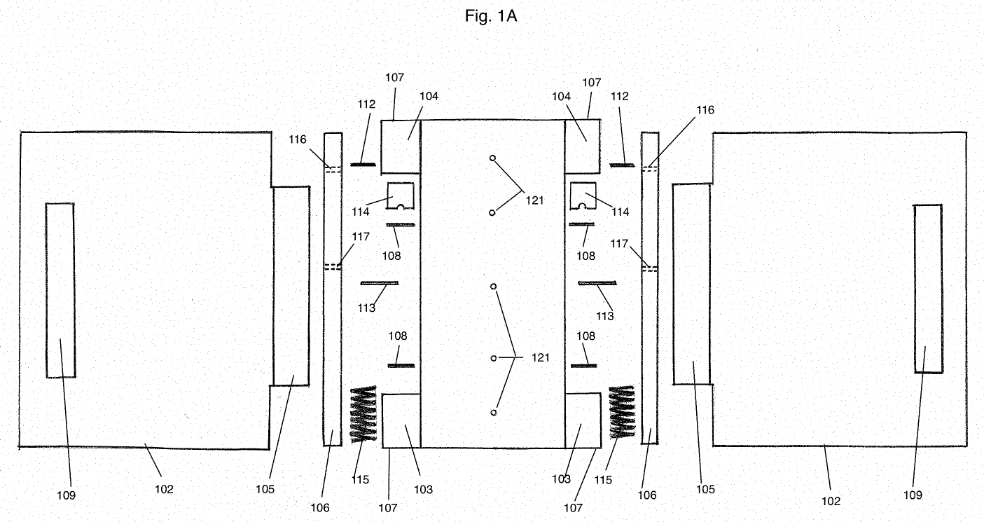

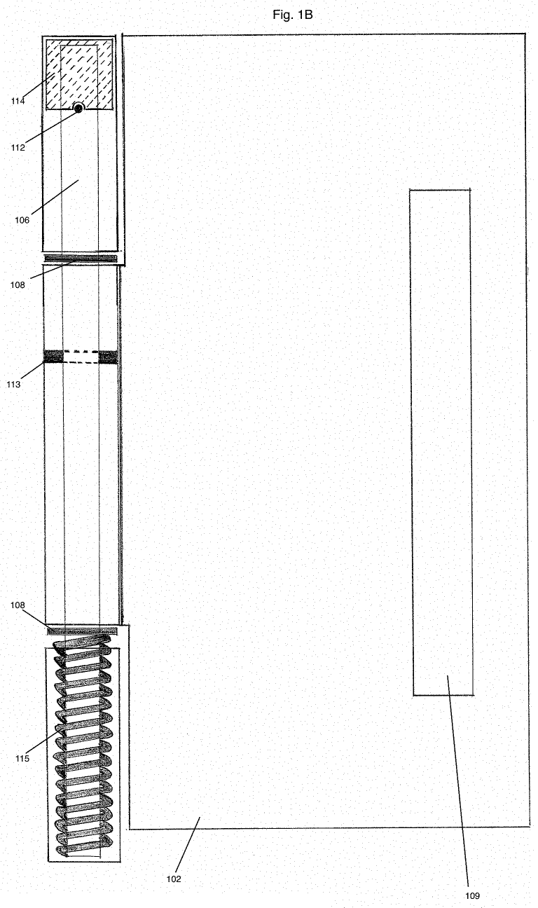

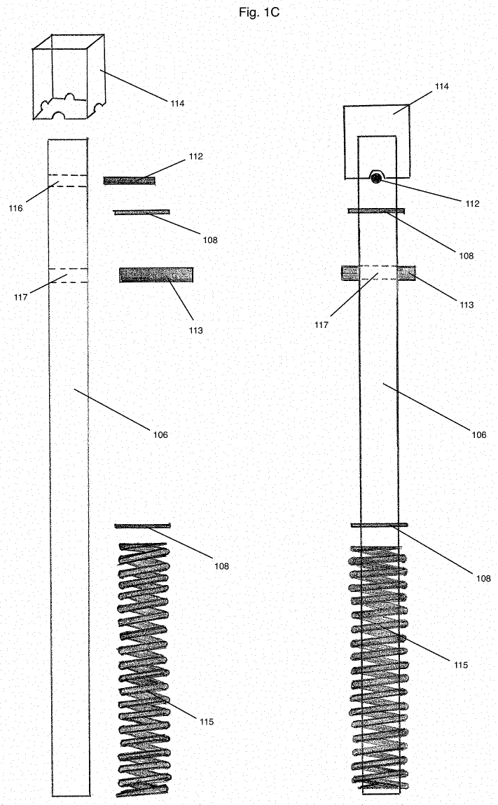

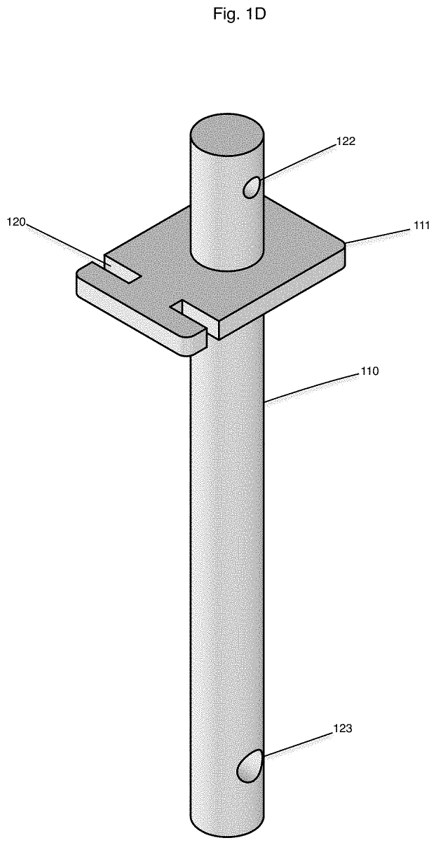

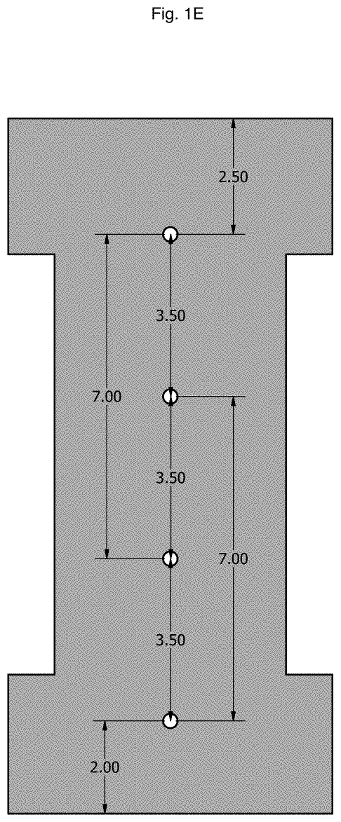

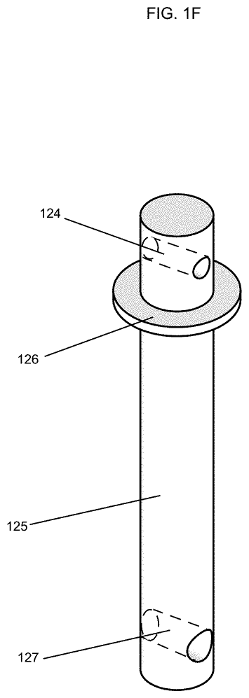

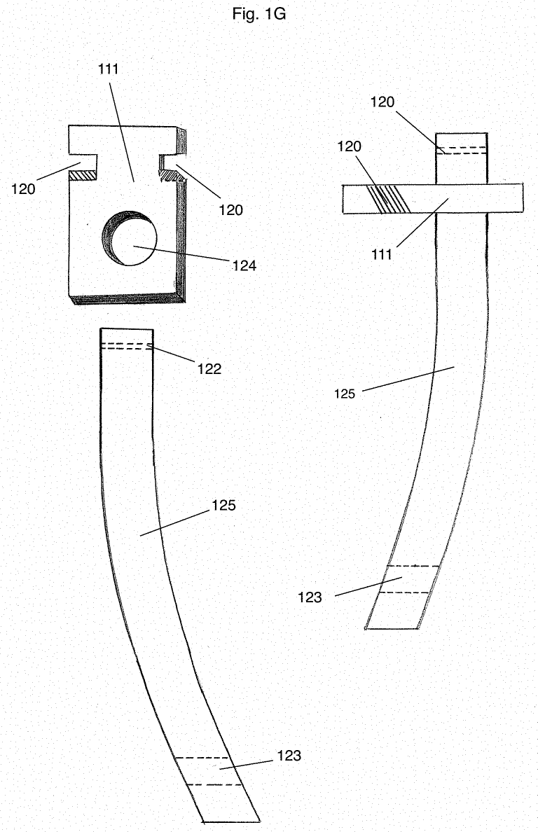

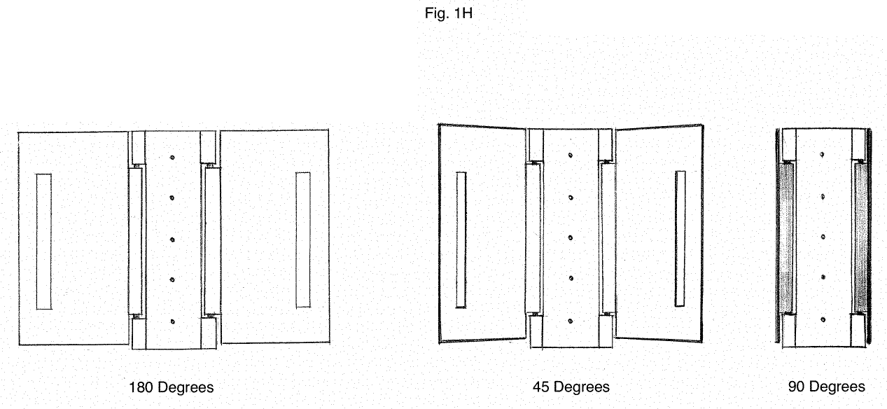

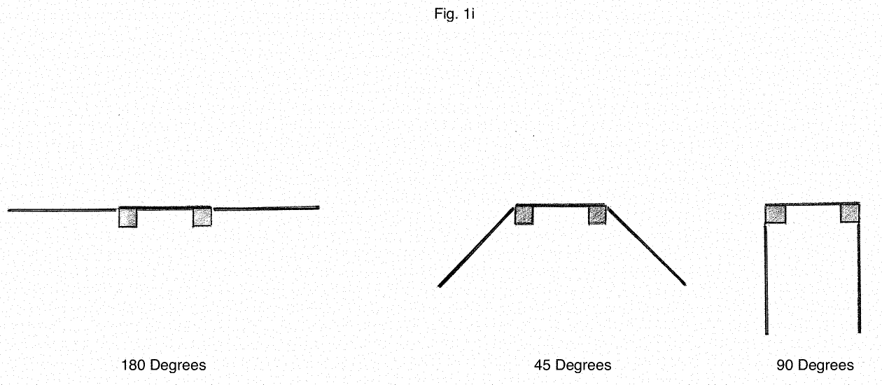

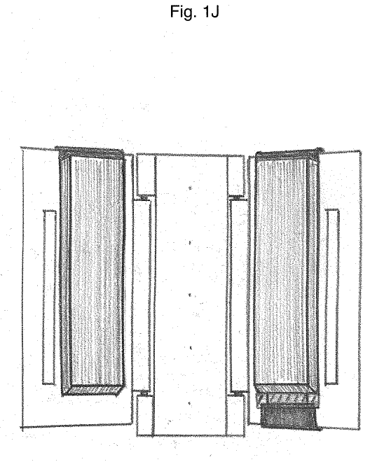

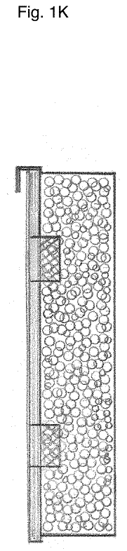

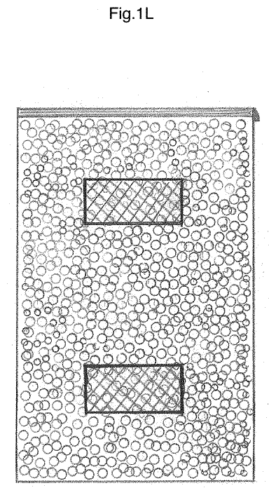

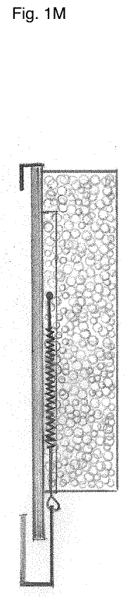

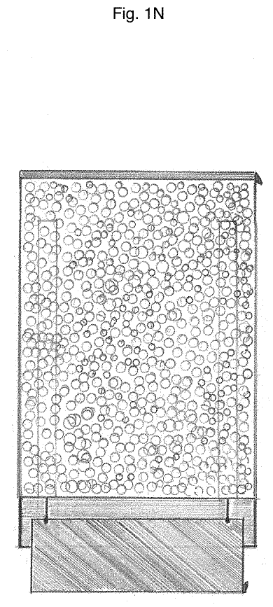

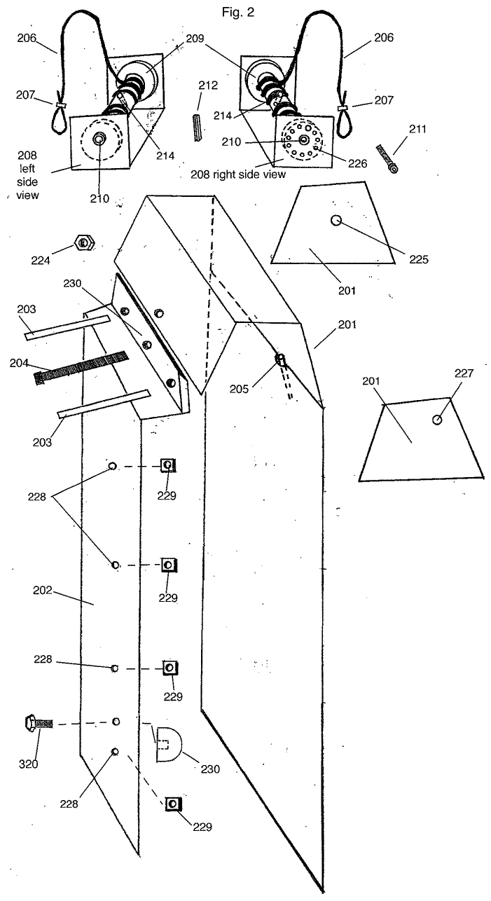

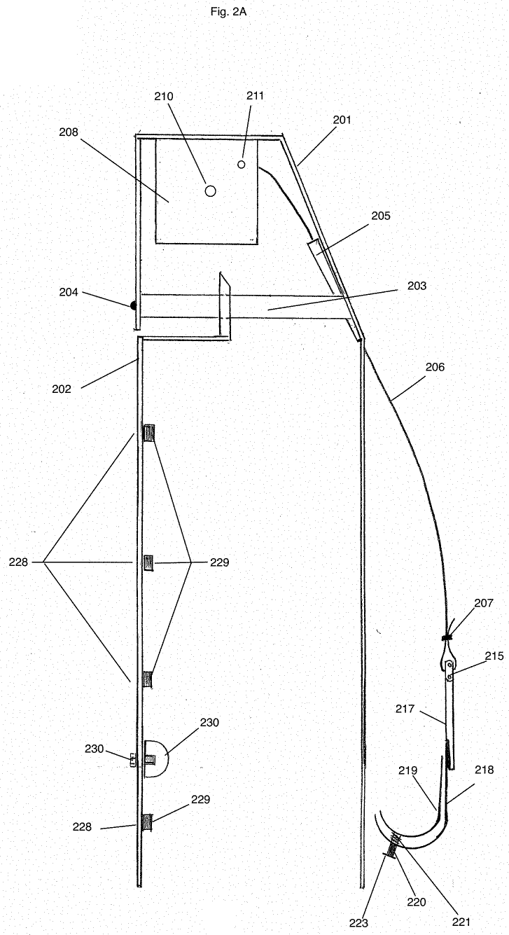

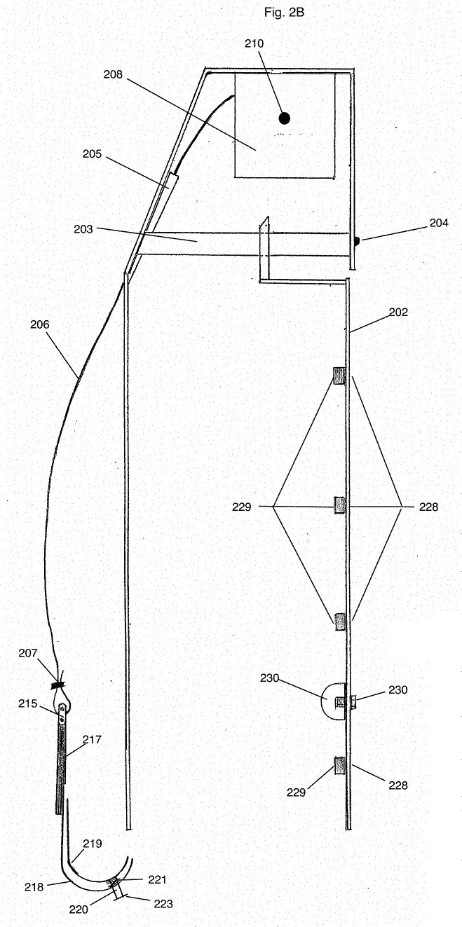

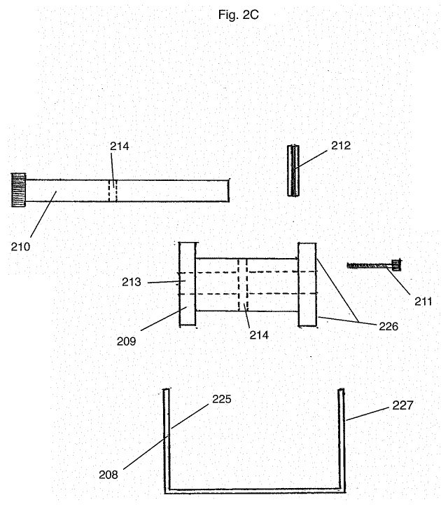

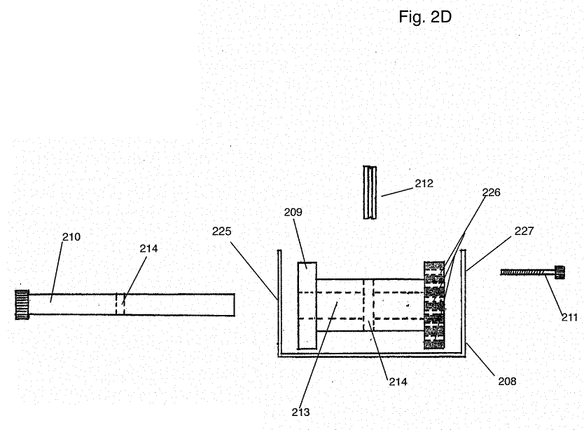

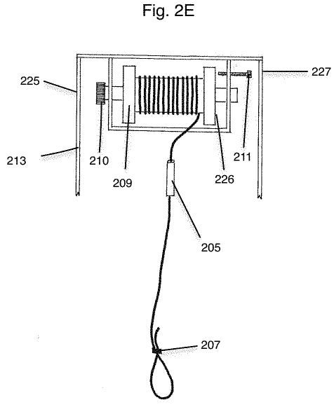

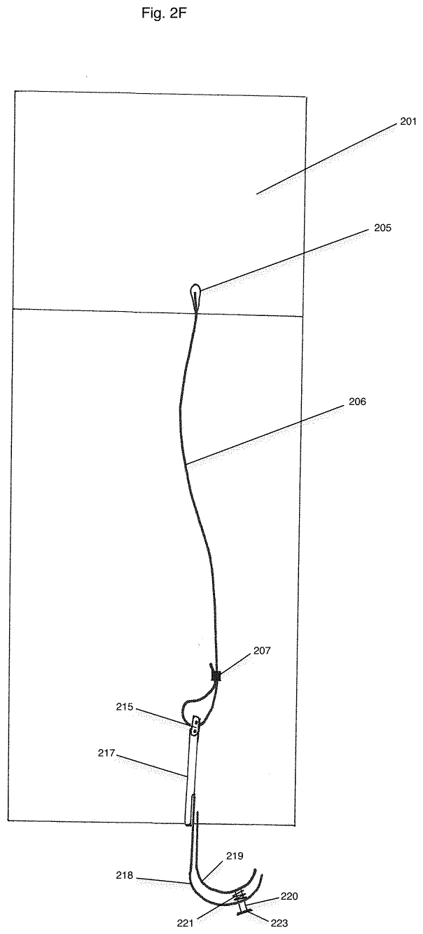

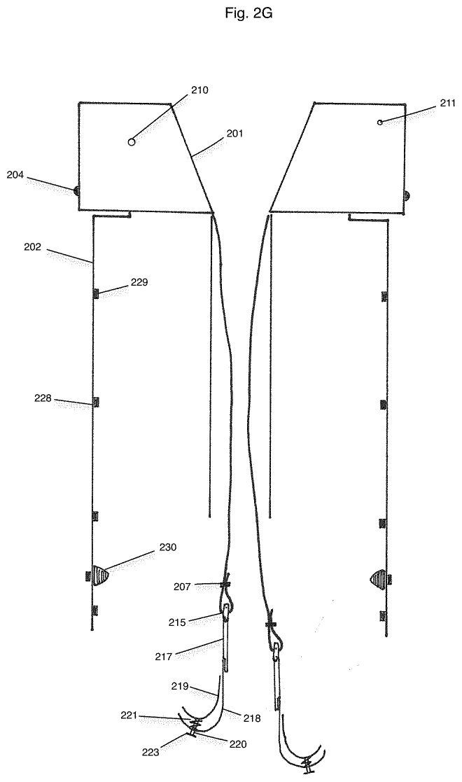

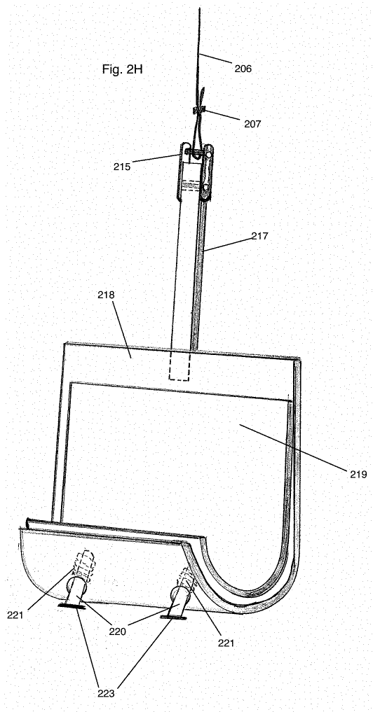

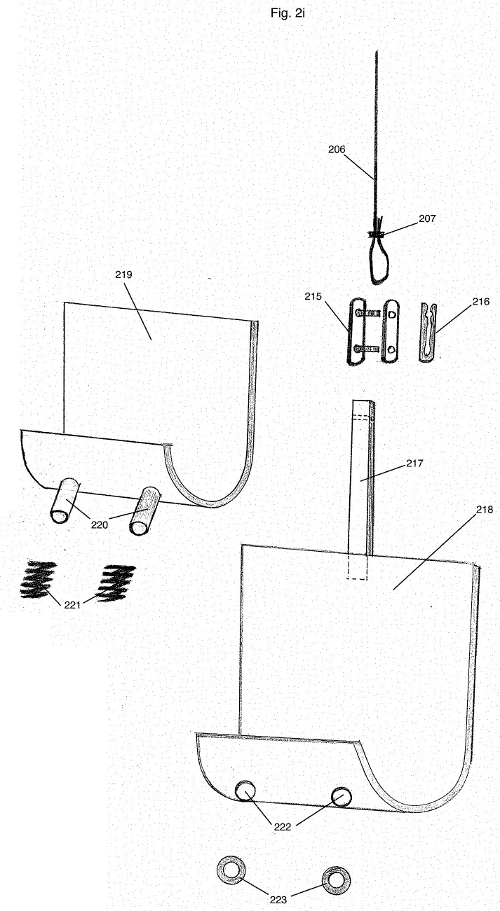

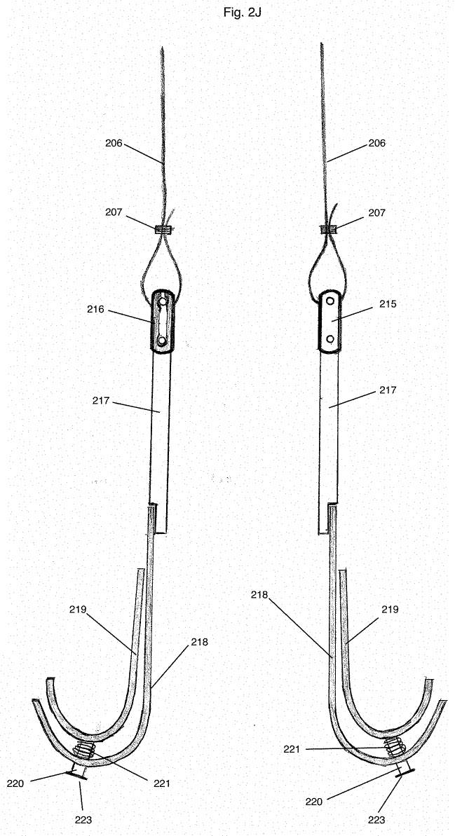

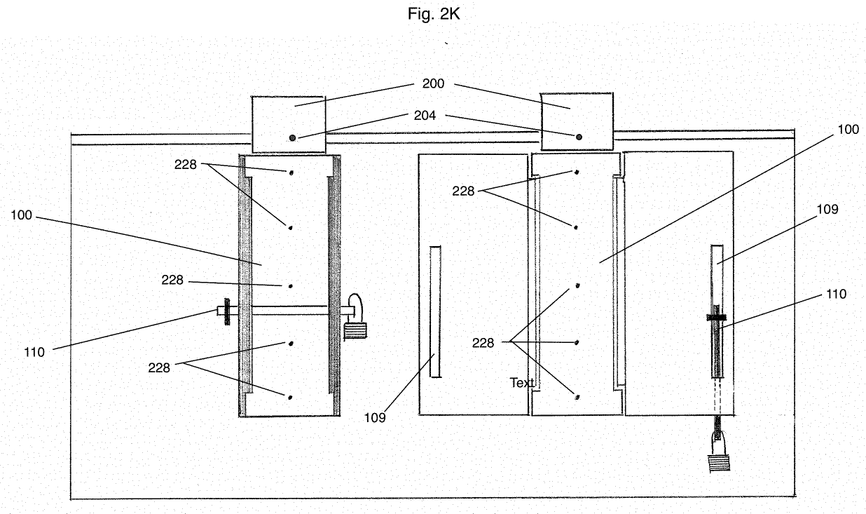

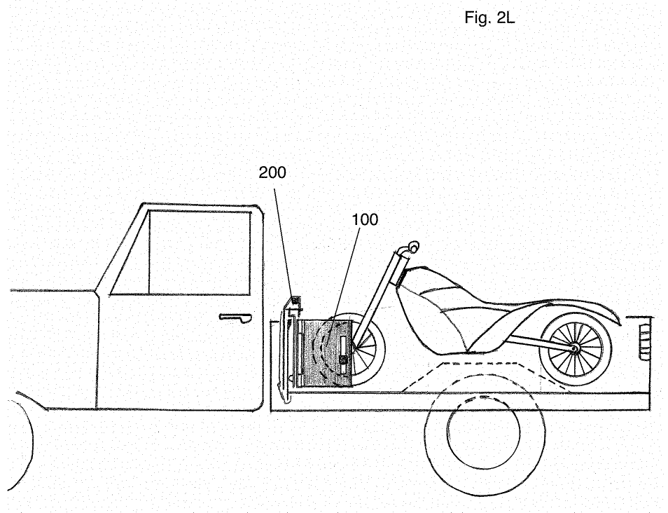

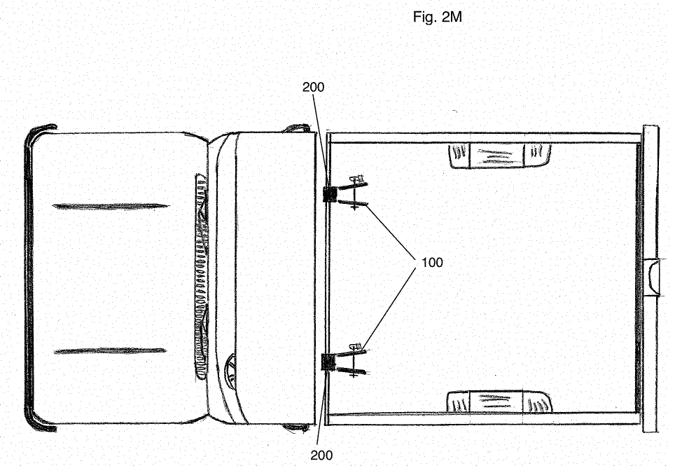

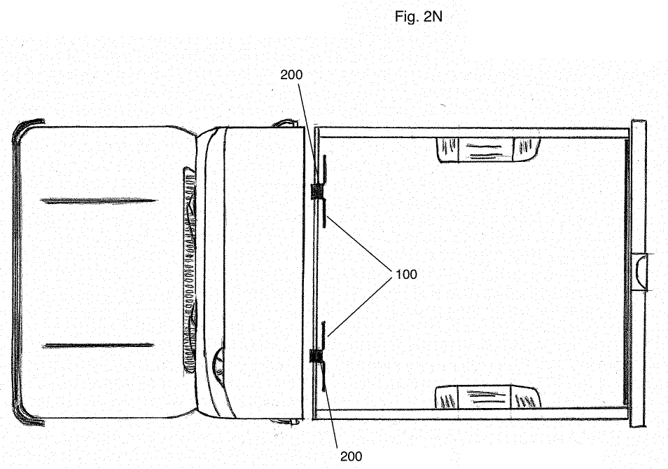

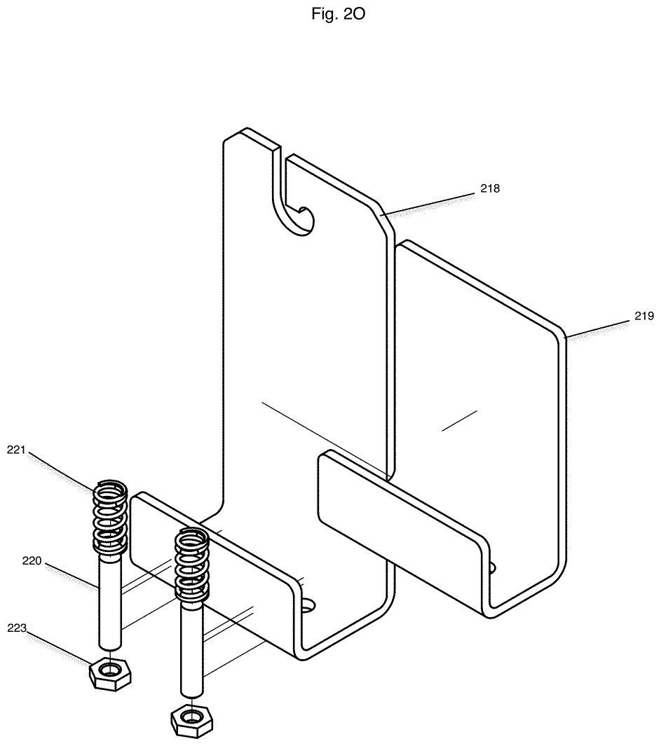

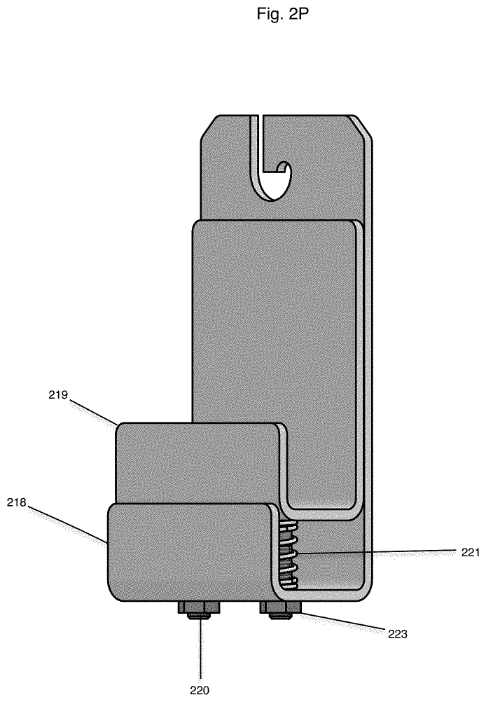

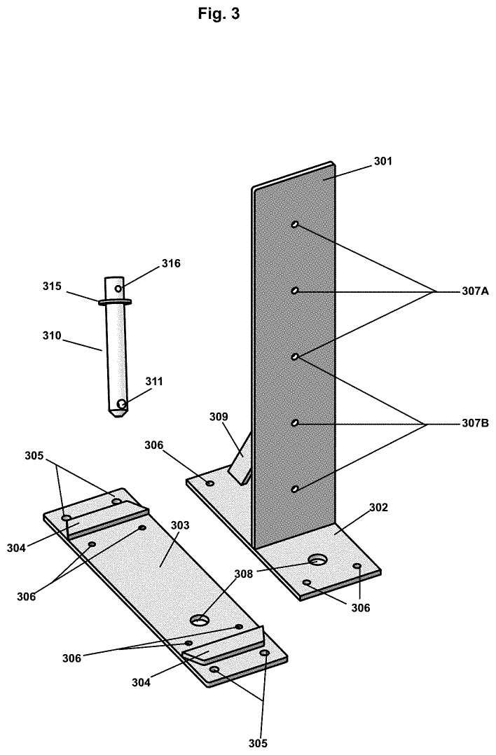

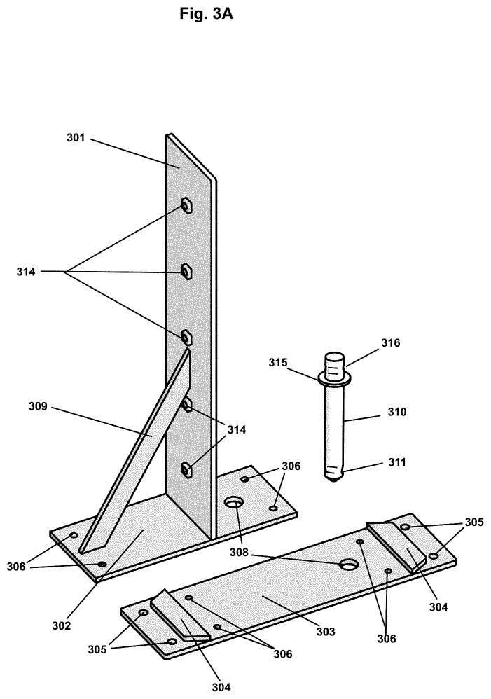

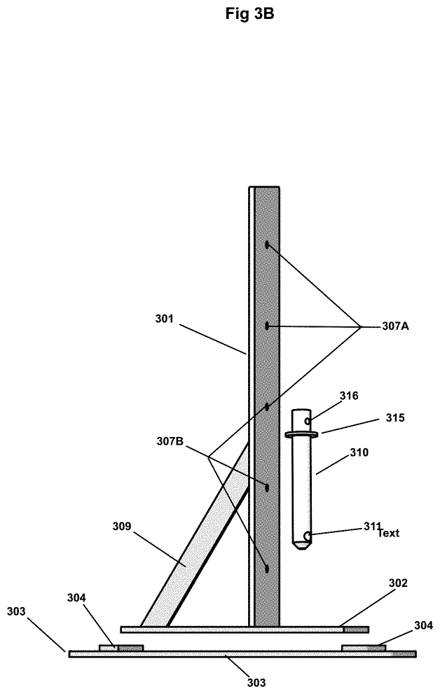

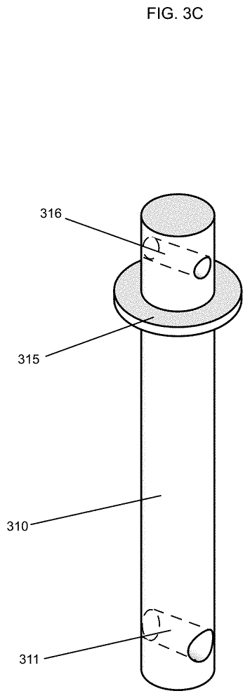

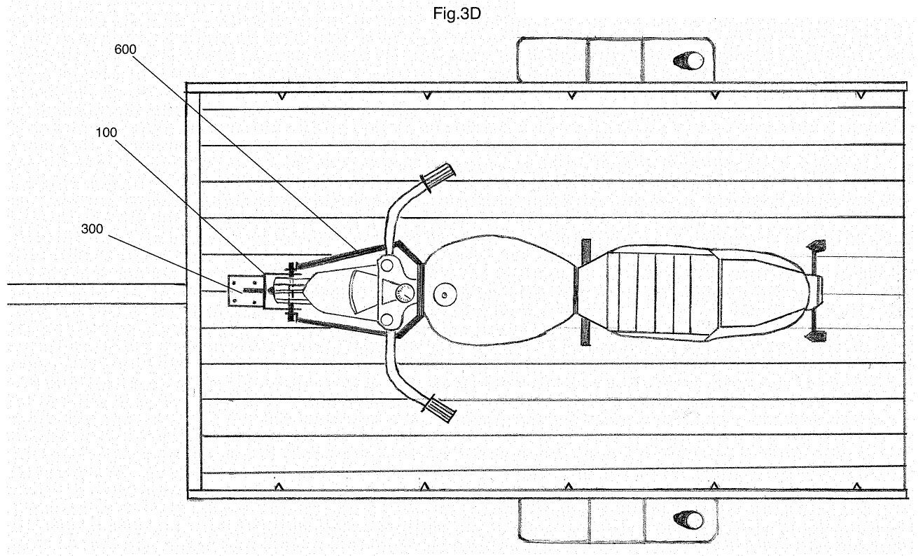

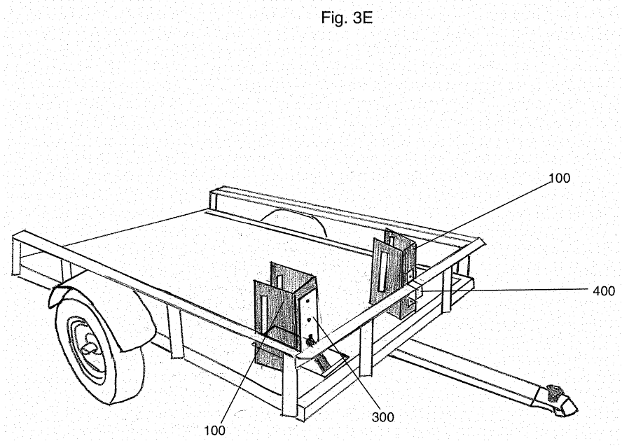

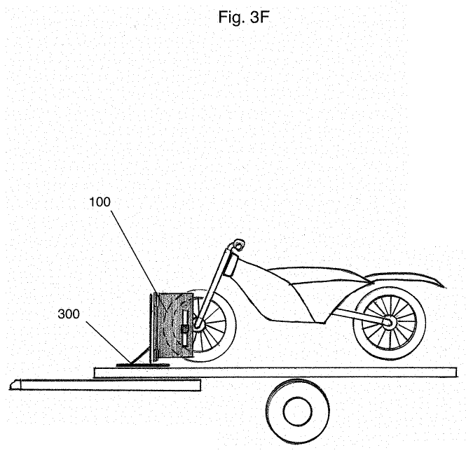

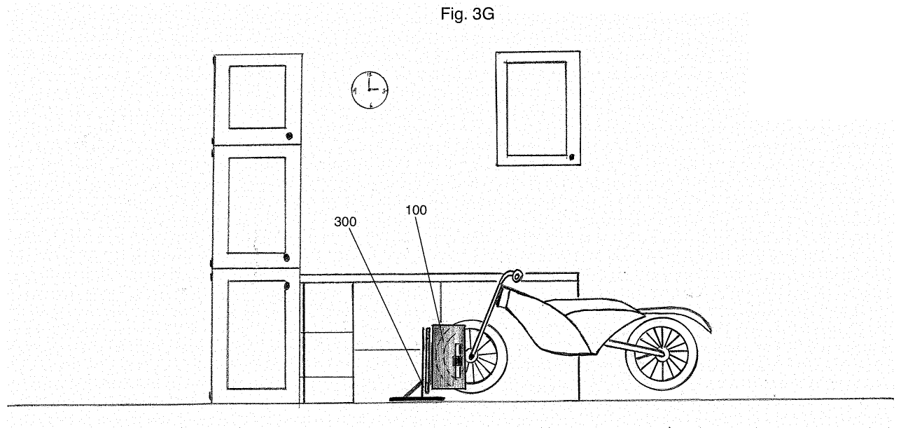

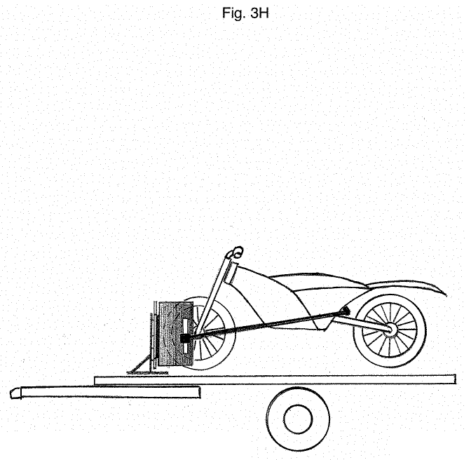

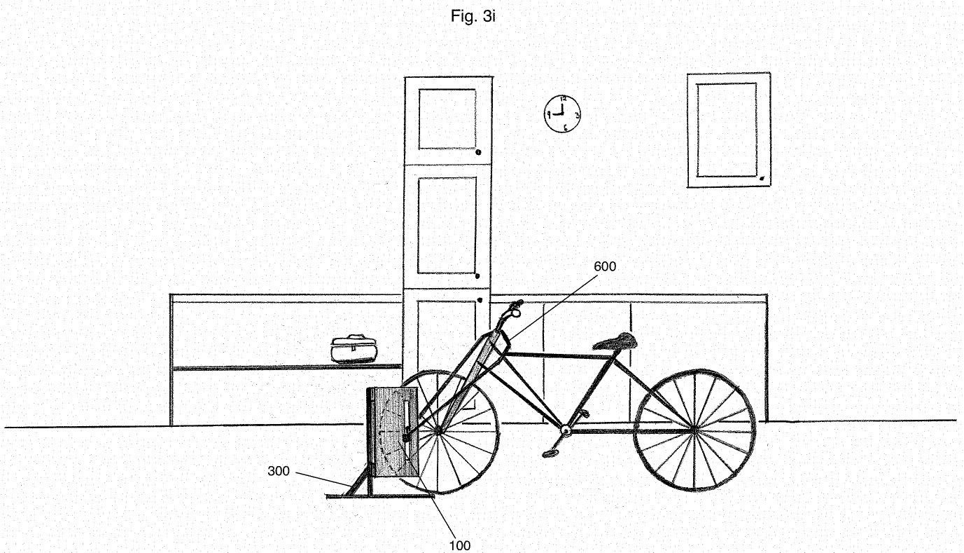

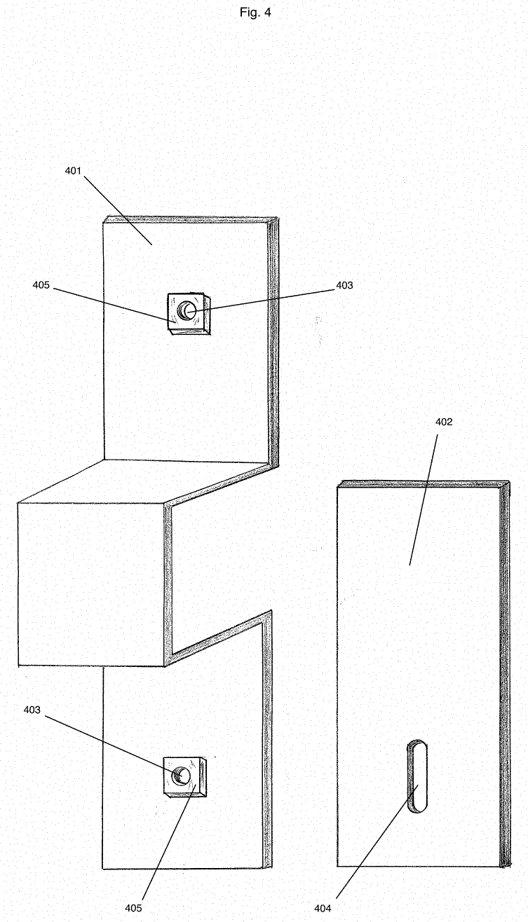

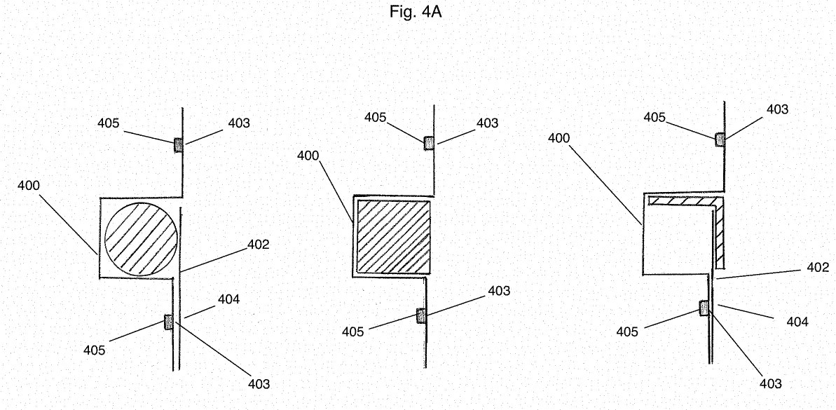

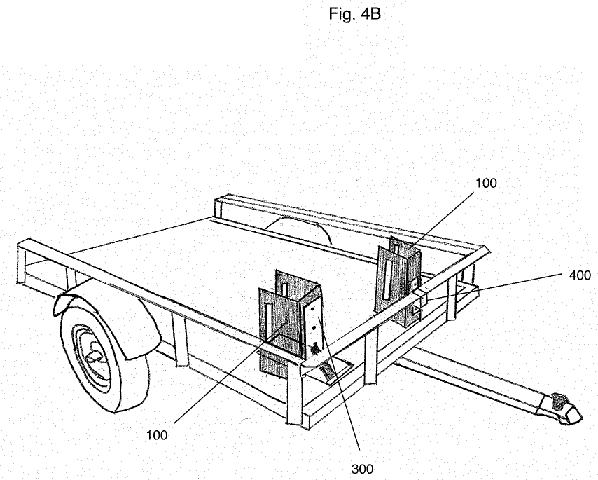

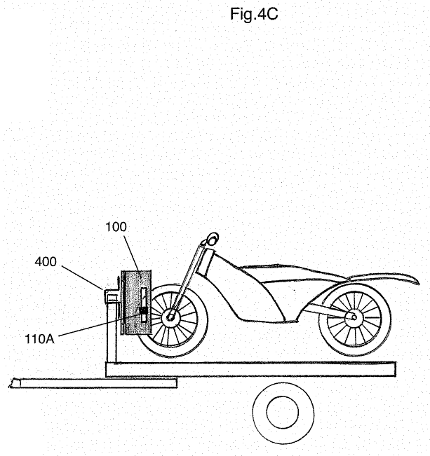

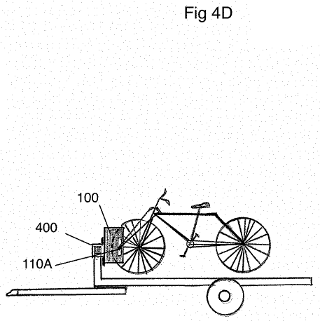

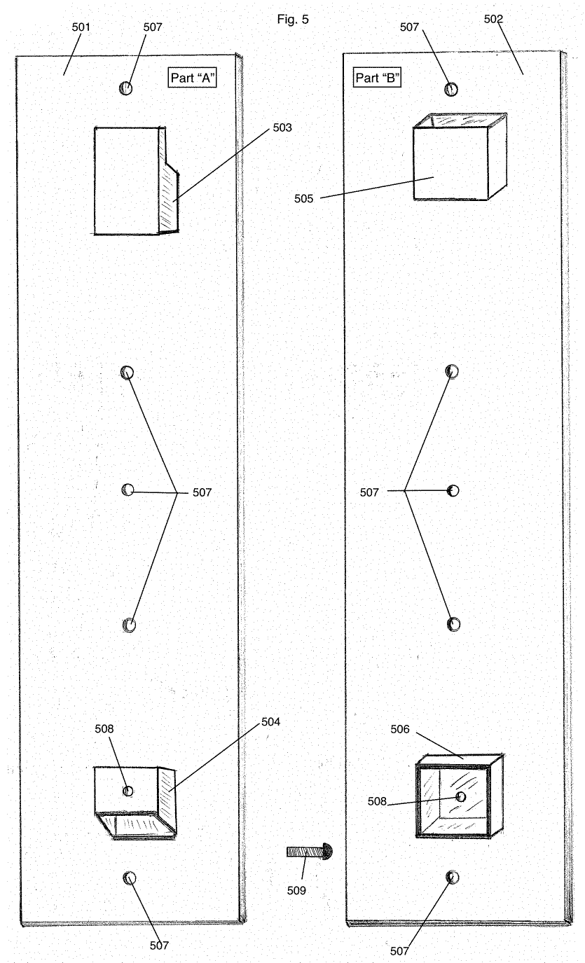

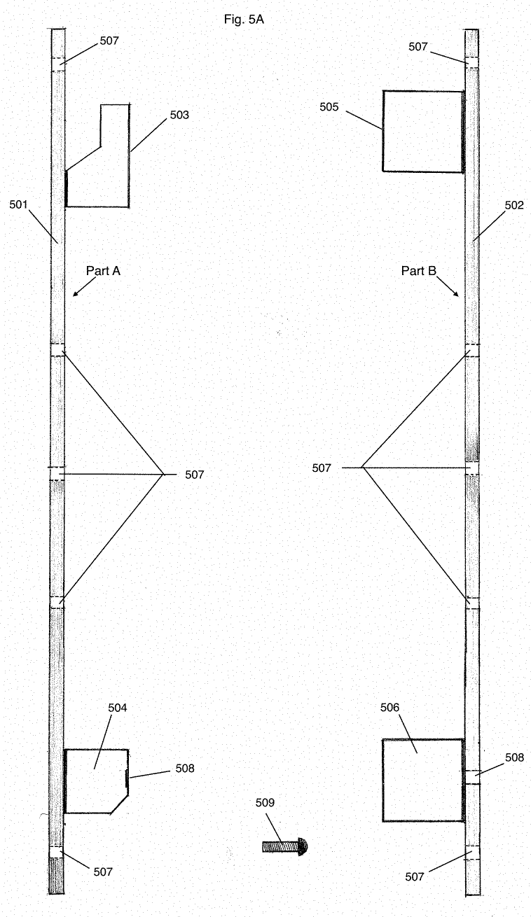

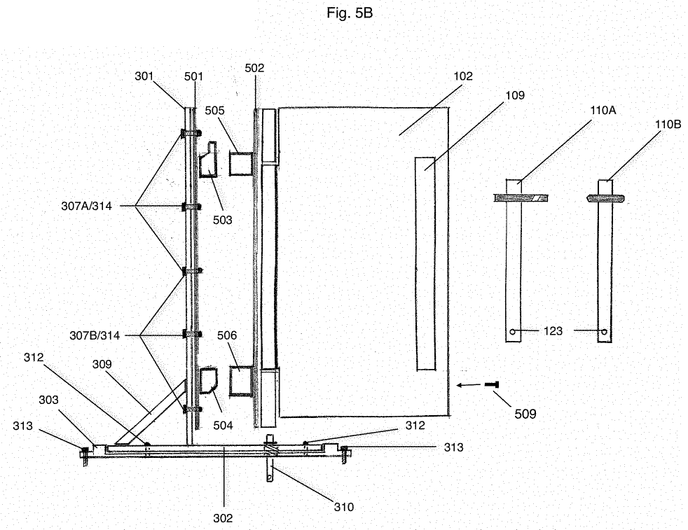

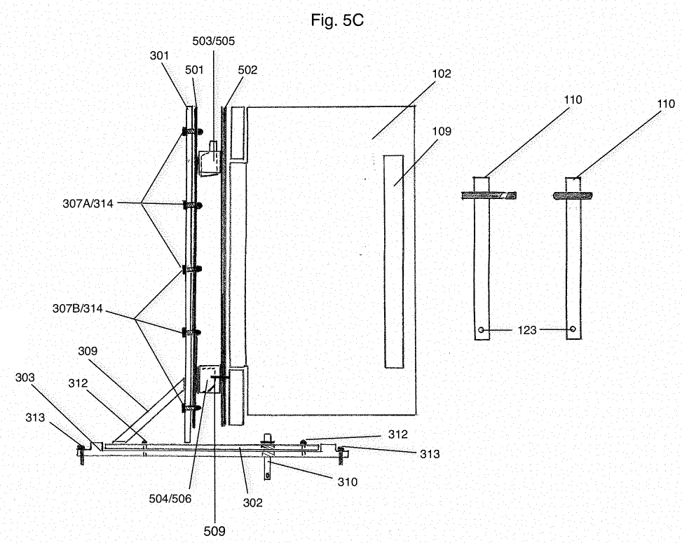

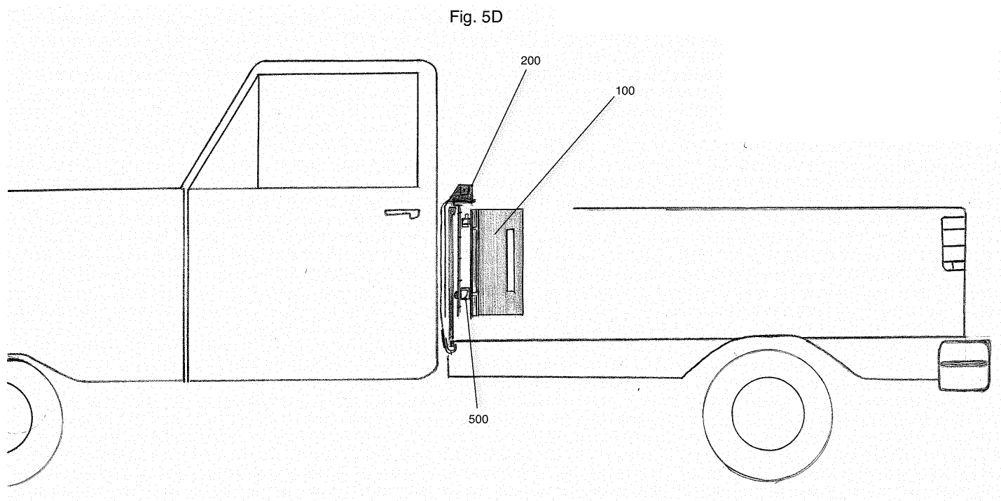

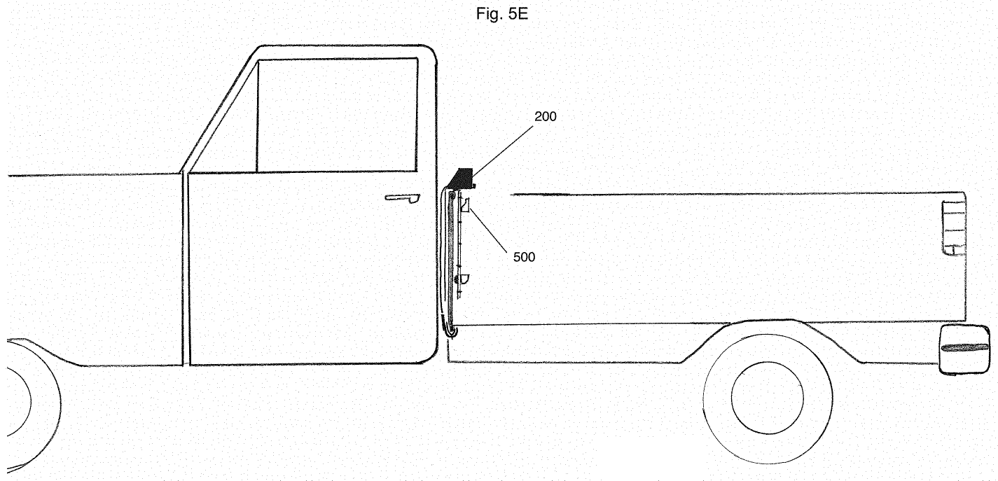

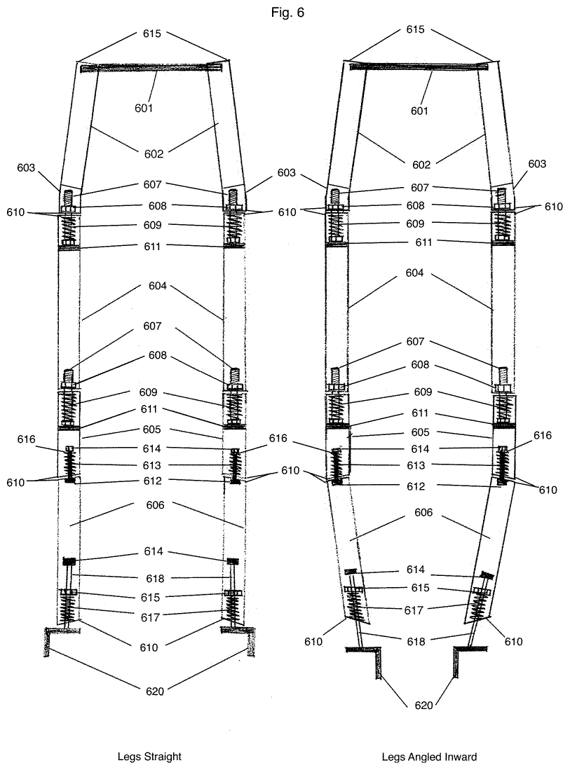

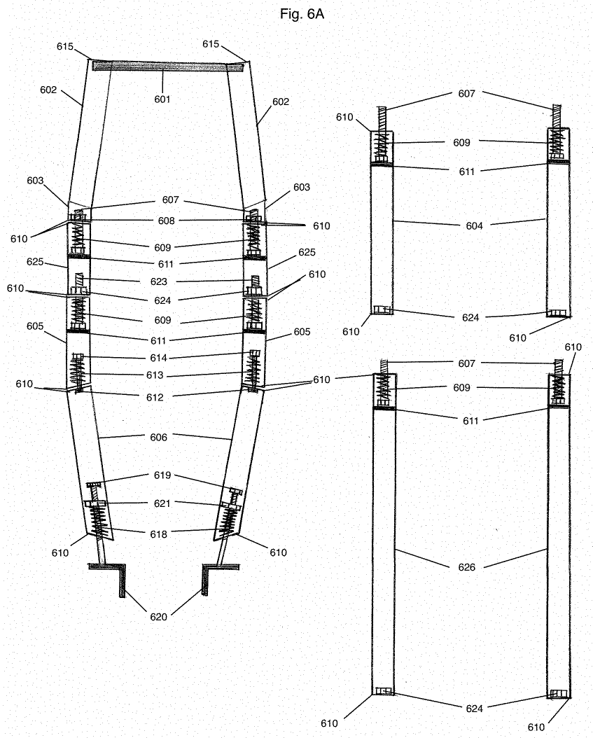

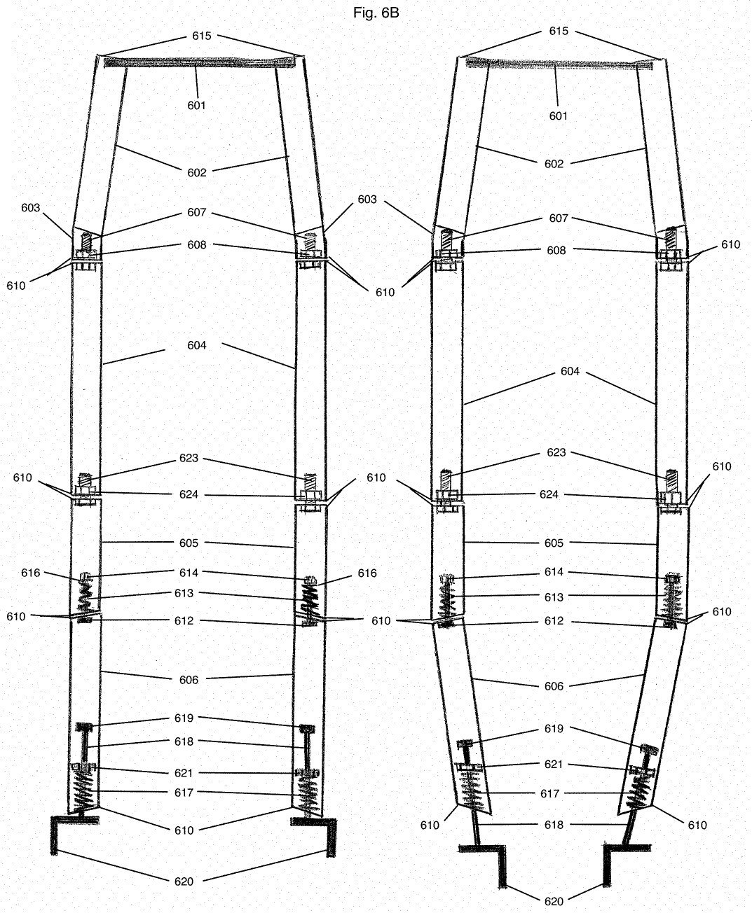

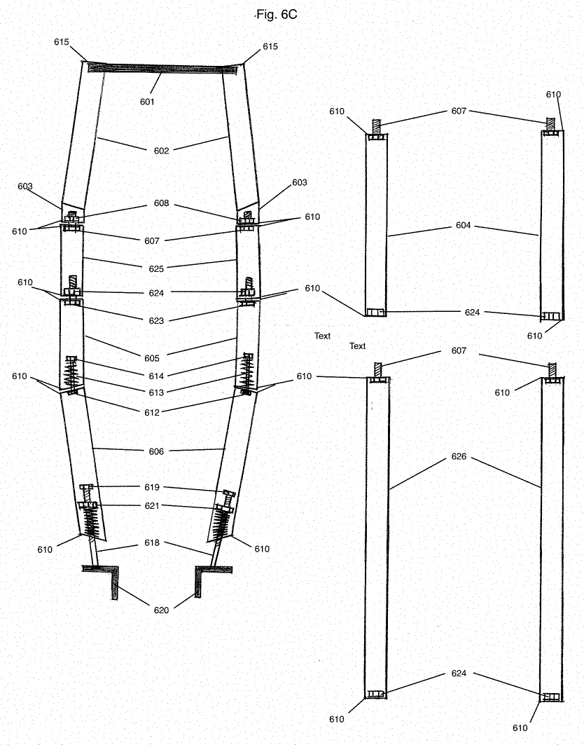

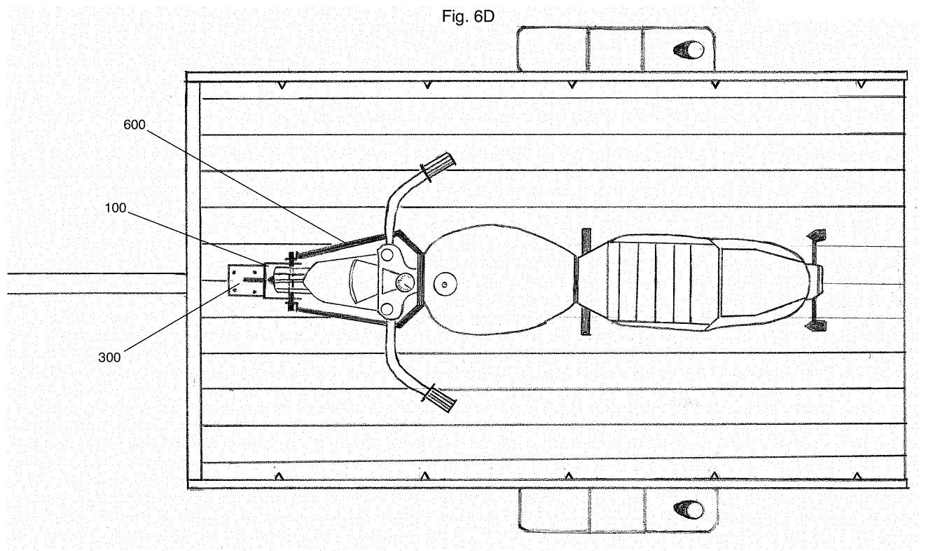

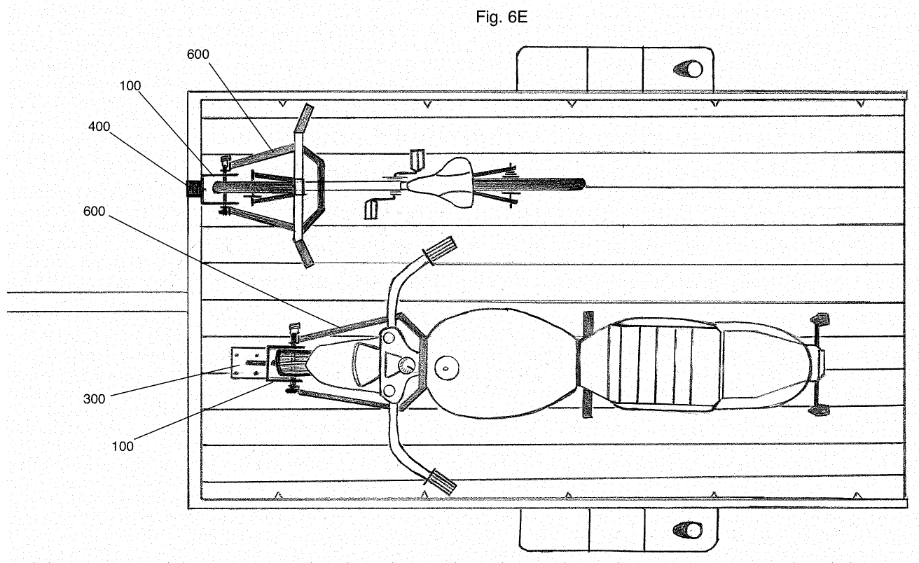

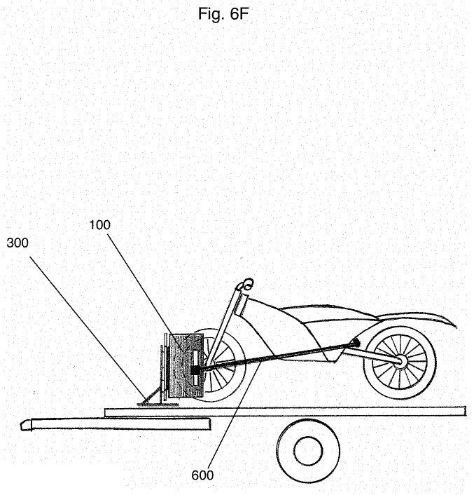

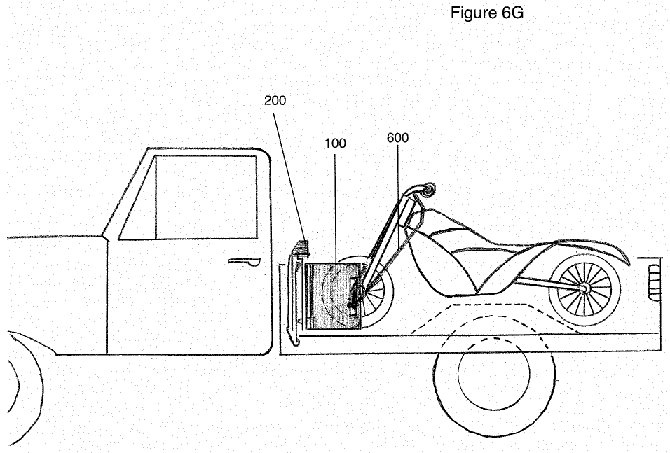

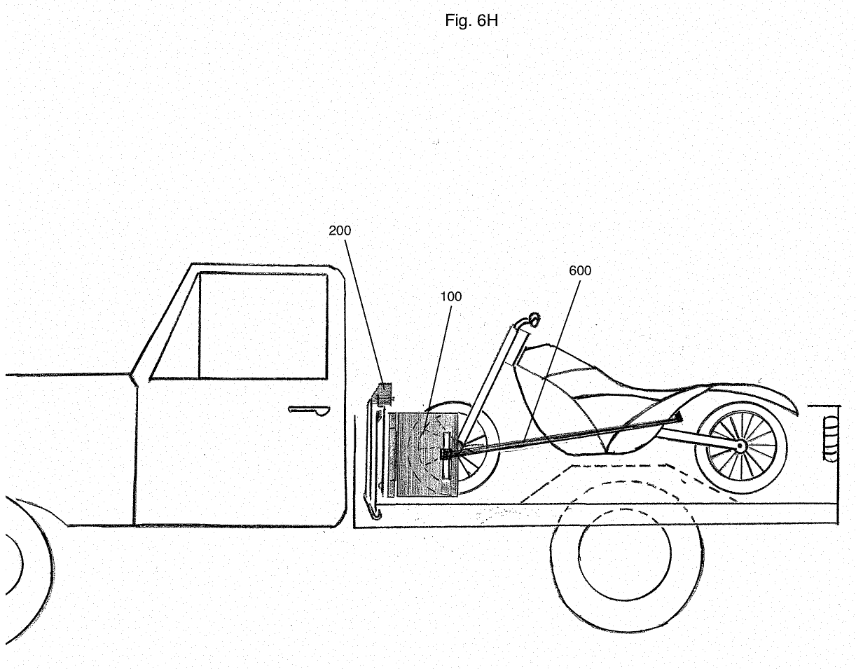

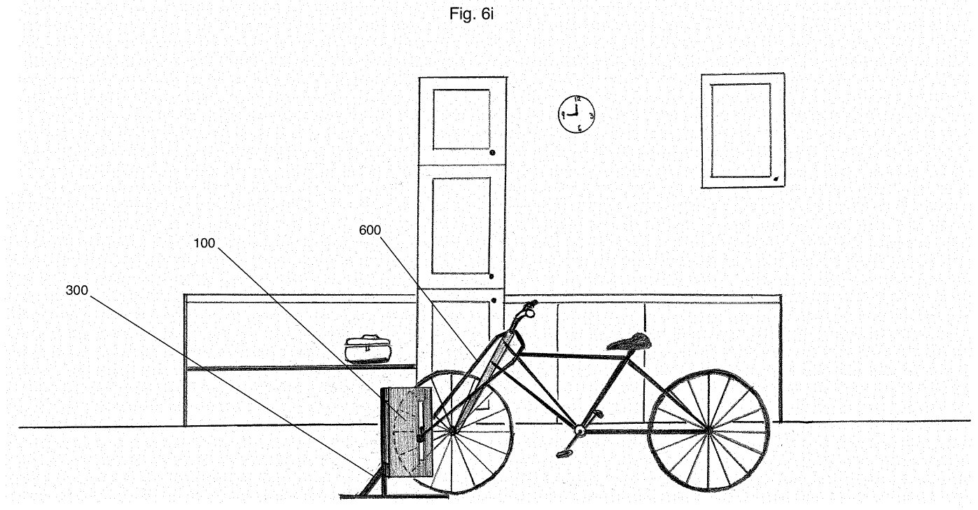

What is claimed is:

1. A motorcycle and/or bicycle wheel chock and anti-theft embodiment that is able to be easily used with the securement collar assembly and interchangeable with multiple mounting assemblies as to be used in pickup trucks, trucks or trailers to maximize security and cargo floor space. Said wheel chock comprising:
A solid backing plate with mounting holes, hinged sides, hinged doors, solid doors with elongated slots, various mounting assemblies, lockable lock-pin and securement collar assembly.

2. A motorcycle and/or bicycle wheel chock and anti-theft embodiment according to claim 1, wherein said solid backing plate has multiple holes to allow for height adjustment and to allow the backing plate to be attached to various mounting assemblies as to be on various vehicles and trailers.

3. A motorcycle and/or bicycle wheel chock and anti-theft embodiment according to claim 1, wherein said solid backing plate has hinges on both sides to accommodate the hinged doors.

4. A motorcycle and/or bicycle wheel chock and anti-theft embodiment according to claim 1, wherein said hinged doors that are moveable from 180 degrees to 0 degrees. The doors have internal mechanisms inside the hinges that allow the doors to be secured at the 180 degree position and the 90 degree position. The range of degrees from 180 to 0 allows the user to mount a motorcycle and/or bicycle at different angles for their needs and when not in use the user can arrange the moveable doors to allow for maximum floor space for cargo.

5. A motorcycle and/or bicycle wheel chock and anti-theft embodiment according to claim 1, wherein said hinged doors each have elongated slots to whereas a lockable lock-pin can be inserted and secured. The lock-pin is to be inserted through the elongated slot of one door, pass through the wheel of the motorcycle and/or bicycle then exiting through the elongated slot of the second door and then a locking devise can secure the lock-pin.

6. A motorcycle and/or bicycle wheel chock and anti-theft embodiment according to claim 1, wherein said securement collar assembly is used either around the steering column and frame attaching to the chock assembly's lock pin for securement or between the rear tire and the frame attaching to the wheel chock assembly's lock pin for securement. The securement collar assembly is made of multiple sections that allow the user to re-configure the length to accommodate different types and or style of motorcycles and/or bicycles.

7. A motorcycle and/or bicycle wheel chock and anti-theft embodiment according to claim 1, wherein said this is one of the various mounting assemblies called the pickup truck bed mount. The pickup truck bed mount assembly with the wheel chock mounted to it, is then installed to the front wall of the pickup truck bed and then ready to receive a wheel of a motorcycle and/or bicycle. The pickup bed mount assembly is designed so that the user can install multiple units on the pickup bed wall so they can haul multiple motorcycles and/or bicycles. The pickup bed mount assembly is designed to utilize the wheel chocks moveable doors so that when the doors are flattened out to the 180 degree position the user will have maximum cargo space available when not hauling motorcycles and/or bicycles. Another design of the pickup bed mount assembly is that is can be quickly be installed and uninstalled by the user in case the user needs to switch pickup truck.

8. A motorcycle and/or bicycle wheel chock and anti-theft embodiment according to claim 1, wherein said this is one of the various mounting assemblies called the floor mount assembly. The floor mount assembly with the wheel chock mounted to it, that once secured to the floor of a pickup truck, flat bed truck, trailer or garage is then ready to receive a wheel of a motorcycle and/or bicycle. The floor mount assembly is designed so that the user can install multiple units on the floor of a pickup truck bed, flat bed truck, trailer or garage so they can haul or store multiple motorcycles and/or bicycles. The floor mount assembly is designed that the upright structure that the wheel chock assembly mounts directly to can be easily detached from the base that is securely bolted to the floor of a pickup truck bed, flat bed truck, trailer or garage floor to allow for maximum floor cargo area usage.

9. A motorcycle and/or bicycle wheel chock and anti-theft embodiment according to claim 1, wherein said this is one of the various mounting assemblies called the rail mount assembly. The rail mount assembly has offset design bends specifically engineered to facilitate the backing plate function to act as a wedge to secure the rail mount assembly by clamping tightly onto the various types and sizes, round tube, square tube or angle iron, of utility trailer railings. The rail mount assembly with the wheel chock assembly mounted to it, is then installed to the railing of a trailer and then ready to receive a wheel of a motorcycle and/or bicycle. The rail mount assembly is designed so that the user can install multiple units on a trailer's railing so they can haul multiple motorcycles and/or bicycles. The rail mount assembly is designed to utilize the wheel chock assembly's moveable doors so that when the doors are flattened out to the 180 degree position the user will have maximum cargo space available when not hauling motorcycles and/or bicycles.

10. A motorcycle and/or bicycle wheel chock and anti-theft embodiment according to claim 1, wherein said this is one of the various mounting assemblies called the detachable mount assembly. The detachable mount assembly with the wheel chock assembly mounted to it and when installed to the one of the other mount assembly's listed above allows the wheel chock assembly to be quickly released from a mount assembly so that the wheel chock assembly can be easily placed into storage. The detachable mount assembly is designed in two parts. One section, part A, is bolted to one of the above mentioned mounting assembly and the other section, part B, is bolted to the wheel chock assembly. With the removal or installation of one bolt the wheel chock assembly and detachable mount assembly part B is quickly removed or re-installed.
